(19) United States
(12) Patent Application Publication
(10) Pub. No.: US 2019/0035510 A1
(43) Pub. Date: Jan. 31, 2019

(54) COOLING SYSTEM FOR NUCLEAR REACTOR

(71) Applicant: Terrestrial Energy Inc., Oakville (CA)

(72) Inventors: David LEBLANC, Ottawa (CA); Anthonius C. RODENBURG, Mississauga (CA)

(21) Appl. No.: 16/073,666

(22) PCT Filed: Jan. 27, 2017
(86) PCT No.: PCT/CA2017/050095

§ 371 Date: Jul. 27, 2018

Related U.S. Application Data
(60) Provisional application No. 62/288,790, filed on Jan. 29, 2016.

(51) Int. Cl. G21C 15/18; G21C 15/253; G21C 15/26; G21C 19/08

(52) U.S. Cl. CPC G21C 15/18; G21C 19/08; G21C 15/26; G21C 15/253

(57) ABSTRACT

A cooling system to remove decay heat removal from a nuclear core of a nuclear reactor when the nuclear reactor cesses to operate due to unforeseen conditions such as, for example, loss of electrical power to pumps circulating the primary coolant in the nuclear reactor. The cooling has a conduit structure that defines a sealed closed circuit through which a cooling fluid circulates through natural convection. In some embodiments, the cooling system of the present disclosure is always functioning. That is, the cooling system continuously extracts heat from the nuclear core. In these embodiments, the cooling system does not need to be actuated in any way when the nuclear reactor shuts down unexpectedly. In other embodiments, the cooling system can be turned on automatically upon loss of electrical power.

### TECHNICAL FIELD

The present disclosure relates to cooling systems for nuclear reactors. In particular, the present disclosure relates to a cooling system for removing decay heat from a reactor.

### BACKGROUND

Previous systems for the fail-safe removal of decay heat of a nuclear reactor have been proposed involving the natural circulation of outside air past the reactor vessel or a guard vessel surrounding the reactor. Decay heat being the residual heat given off by fission products after a nuclear reactor is shut down. Such air cooling systems are possible for reactors that can effectively move decay heat to the walls of the reactor, typically by an internally contained liquid such as liquid sodium or lead coolant in some fast reactor designs. When the power density within the reactor vessel is not too high, the decay heat of such a system can be effectively be removed by those systems.

One drawback is the relatively close proximity of a potential release pathway to the environment in a severe accident scenario. Another drawback is the potential activation of the passing outside air by neutrons emitted from the reactor and the creation of activated Argon 41. Whereas in sodium or lead cooled fast reactor concepts there is ease to provide a thick, neutron absorbing layer of sodium or lead between the reactor core and the reactor vessel, in other potential use such as with Molten Salt Reactors (MSR) or Fluoride cooled High temperature Reactors (FHR), where decay heat can also be transmitted effectively to the reactor vessel wall, such internal neutron shielding is more problematic and avoiding activation of outside air is problematic.

Therefore, improvements in decay heat removal systems are desirable.

### SUMMARY

In a first aspect, the present disclosure provides a cooling system for a nuclear reactor. The system comprises: a conduit structure defining a sealed closed circuit. The conduit structure is formed outside the nuclear reactor. The conduit structure is to hold a gas therein. The conduit structure has a first portion in thermal contact with the nuclear reactor. The first portion is configured to transfer heat from the nuclear reactor to the gas present in the first portion. The heat transferred to the gas is to heat the gas in order to obtain heated gas. The conduit structure has a second portion located higher than the first portion. The second portion is in thermal contact with an environment. The conduit structure is configured for the heated gas to propagate, by natural convection, from the first portion to the second portion. The heated gas is to propagate through the second portion and to transfer heat to the environment as the heated gas propagates through the second portion. The heated gas is to cool during propagation through the second portion in order to obtain cooled gas. The conduit structure defines a return portion for returning the cooled gas to the first portion. The cooling system is configured to continuously remove heat from the nuclear reactor during operation of the nuclear reactor and when the nuclear reactor stops operating and generates decay heat.

In some instances, the first portion of the conduit structure can be configured to receive heat from the nuclear reactor through at least one of heat radiation, heat conduction, and heat convection.

In some instances, the first portion can be cylindrically shaped and surround the nuclear reactor.

In some instances, the second portion of the conduit structure can define a wall.

In some instances, the second portion of the conduit structure can further define a ceiling portion formed above the wall portion.

In some instances, the second portion of the conduit structure can further define a roof portion that extends over the ceiling portion.

In some instances, the ceiling portion can extend from the wall portion at an angle ranging between 2 and 10 degrees.

In some instances, the roof portion defines a dome.

In some instances, the second portion can comprise a cooling tower. The cooling tower can define a hyperbolic shape.

In some instance, the conduit structure further comprises a vault for storing spent nuclear fuel, a riser for fluidly connecting the vault to the second portion, and an ancillary conduit fluidly connecting the vault to the return portion.

In some instances, the gas can include at least one of air, nitrogen and carbon dioxide.

In some instances, the system can further comprise one or more than one vault for storing spent nuclear fuel; and a vault cooling system for cooling the one or more than one vault. The vault cooling system comprises: an additional conduit structure defining an additional sealed closed circuit The additional conduits structure is to hold another gas therein. The additional conduit structure has a first portion in thermal contact with the one or more than vault. The first portion of the additional conduit structure is configured to transfer heat from the one or more than one vault to the other gas present in the first portion of the additional conduit structure. The heat transferred to the other gas is to heat the other gas in order to obtain another heated gas. The additional conduit structure has a second portion located higher than the first portion and the second portion of the additional conduit structure is in thermal contact with another environment. The additional conduit structure is configured for the heated other gas to propagate, by natural convection, from the first portion of the additional conduit structure to the second portion of the additional conduit structure. The heated other gas is to propagate through the second portion of the additional conduit structure and to transfer heat to the other environment as the heated other gas propagates through the second portion of the additional conduit structure. The heated other gas is to cool during propagation through the second portion of the additional conduit structure in order to obtain cooled other gas. The additional conduit structure defines a return portion for returning the cooled other gas to the first portion of the additional conduit structure. The vault cooling system is configured to remove heat from the one or more than one vault during operation of the nuclear reactor and when the nuclear reactor stops operating.

In some instances, the environment and the other environment are the same.

In some embodiments, the environment is an outside environment.

In another aspect, the present disclosure provides a cooling system for a nuclear reactor. The system comprises: a conduit structure defining a sealed closed circuit. The conduit structure is formed outside the nuclear reactor. The conduit structure is to hold a gas therein. The conduit structure has a first portion in thermal contact with the nuclear reactor. The first portion is configured to transfer heat from the nuclear reactor to the gas present in the first portion. The heat transferred to the gas is to heat the gas in order to obtain heated gas. The conduit structure has a second portion located higher than the first portion. The second portion is in thermal contact with an environment. The conduit structure is configured for the heated gas to propagate, by natural convection, from the first portion to the second portion. The heated gas is to propagate through the second portion and to transfer heat to the environment as the heated gas propagates through the second portion. The heated gas is to cool during propagation through the second portion in order to obtain cooled gas. The conduit structure defines a return portion for returning the cooled gas to the first portion. The cooling system is configured to remove heat from the nuclear reactor when the nuclear reactor stops operating and generates decay heat.

In some instances, the conduit structure comprises a closure or more than one closure that prevents the gas from flowing through the conduit structure when the nuclear reactor operates. In some instances, the closure or more than one closure can be a louver or more than one louver. In some instance, the cooling system can comprise a controller configured to maintain the closure or more than one closure closed when the nuclear reactor operates and to open the closure or more than one closure when the reactor stops operating.

In some instances, the first portion of the conduit structure can be configured to receive heat from the nuclear reactor through at least one of heat radiation, heat conduction, and heat convection.

In some instances, the first portion can be cylindrically shaped and surround the nuclear reactor.

In some instances, the second portion of the conduit structure can define a wall.

In some instances, the second portion of the conduit structure can further define a ceiling portion formed above the wall portion.

In some instances, the second portion of the conduit structure can further define a roof portion that extends over the ceiling portion.

In some instances, the ceiling portion can extend from the wall portion at an angle ranging between 2 and 10 degrees.

In some instances, the roof portion defines a dome.

In some instances, the second portion can comprise a cooling tower.

In some instance, the conduit structure further comprises a vault for storing spent nuclear fuel, a riser for fluidly connecting the vault to the second portion, and an ancillary conduit fluidly connecting the vault to the return portion.

In some instances, the gas can include at least one of air, nitrogen and carbon dioxide.

In some instances, the system can further comprise one or more than one vault for storing spent nuclear fuel; and a vault cooling system for cooling the one or more than one vault. The vault cooling system comprises: an additional conduit structure defining an additional sealed closed circuit. The additional conduits structure is to hold another gas therein. The additional conduit structure has a first portion in thermal contact with the one or more than vault. The first portion of the additional conduit structure is configured to transfer heat from the one or more than one vault to the other gas present in the first portion of the additional conduit structure. The heat transferred to the other gas to heat the other gas in order to obtain another heated gas. The additional conduit structure has a second portion located higher than the first portion and the second portion of the additional conduit structure is in thermal contact with another environment. The additional conduit structure is configured for the heated other gas to propagate, by natural convection, from the first portion of the additional conduit structure to the second portion of the additional conduit structure. The heated other gas is to propagate through the second portion of the additional conduit structure and to transfer heat to the other environment as the heated other gas propagates through the second portion of the additional conduit structure. The heated other gas is to cool during propagation through the second portion of the additional conduit structure in order to obtain cooled other gas. The additional conduit structure defines a return portion for returning the cooled other gas to the first portion of the additional conduit structure. The vault cooling system configured to remove heat from the one or more than one vault during operation of the nuclear reactor and when the nuclear reactor stops operating.

In some instances, the environment and the other environment are the same.

In some embodiments, the environment is an outside environment.

In another aspect, the present disclosure provides a cooling system that comprises a nuclear reactor cooling system and a distinct vault cooling system.

In same instances, the nuclear reactor cooling system comprises: a conduit structure defining a sealed closed circuit. The conduit structure is formed outside the nuclear reactor. The conduit structure is to hold a gas therein. The conduit structure has a first portion in thermal contact with the nuclear reactor. The first portion is configured to transfer heat from the nuclear reactor to the gas present in the first portion. The heat transferred to the gas is to heat the gas in order to obtain heated gas. The conduit structure has a second portion located higher than the first portion. The second portion is in thermal contact with an environment. The conduit structure is configured for the heated gas to propagate, by natural convection, from the first portion to the second portion. The heated gas is to propagate through the second portion and to transfer heat to the environment as the heated gas propagates through the second portion. The heated gas is to cool during propagation through the second portion in order to obtain cooled gas. The conduit structure defines a return portion for returning the cooled gas to the first portion. The cooling system is configured to continuously remove heat from the nuclear reactor during operation of the nuclear reactor and when the nuclear reactor stops operating and generates decay heat.

In some instances, the nuclear reactor cooling system comprises a conduit structure defining a sealed closed circuit. The conduit structure is formed outside the nuclear reactor. The conduit structure is to hold a gas therein. The conduit structure has a first portion in thermal contact with the nuclear reactor. The first portion is configured to transfer heat from the nuclear reactor to the gas present in the first portion. The heat transferred to the gas is to heat the gas in order to obtain heated gas. The conduit structure has a second portion located higher than the first portion. The second portion is in thermal contact with an environment. The conduit structure is configured for the heated gas to propagate, by natural convection, from the first portion to the second portion. The heated gas is to propagate through the second portion and to transfer heat to the environment as the heated gas propagates through the second portion. The heated gas is to cool during propagation through the second portion in order to obtain cooled gas. The conduit structure defines a return portion for returning the cooled gas to the first portion. The cooling system is configured to remove heat from the nuclear reactor when the nuclear reactor stops operating and generates decay heat.

In some instances, the vault cooling system comprises an additional conduit structure defining an additional sealed closed circuit. The additional conduit structure is to hold another gas therein. The additional conduit structure has a first portion in thermal contact with the vault. The first portion of the additional conduit structure is configured to transfer heat from the vault to the other gas present in the first portion of the additional conduit structure. The heat transferred to the other gas is to heat the other gas in order to obtain heated other gas. The additional conduit structure has a second portion located higher than the first portion of the additional conduit structure. The second portion of the additional conduit structure is in thermal contact with another environment. The conduit structure is configured for the heated other gas to propagate, by natural convection, from the first portion of the additional conduit structure to the second portion of the additional conduit structure. The heated other gas is to propagate through the second portion of the additional conduit structure and to transfer heat to the other environment as the heated other gas propagates through the second portion of the additional conduit structure. The heated other gas is to cool during propagation through the second portion of the additional conduit structure in order to obtain cooled other gas. The additional conduit structure defines a return portion for returning the cooled gas to the first portion. The vault cooling system is configured to continuously remove heat from the vault.

In some instances, the vault cooling system comprises an additional conduit structure defining an additional sealed closed circuit. The additional conduit structure is to hold another gas therein. The additional conduit structure has a first portion in thermal contact with the vault. The first portion of the additional conduit structure is configured to transfer heat from the vault to the other gas present in the first portion of the additional conduit structure. The heat transferred to the other gas is to heat the other gas in order to obtain heated other gas. The additional conduit structure has a second portion located higher than the first portion of the additional conduit structure. The second portion of the additional conduit structure is in thermal contact with another environment. The conduit structure is configured for the heated other gas to propagate, by natural convection, from the first portion of the additional conduit structure to the second portion of the additional conduit structure. The heated other gas is to propagate through the second portion of the additional conduit structure and to transfer heat to the other environment as the heated other gas propagates through the second portion of the additional conduit structure. The heated other gas is to cool during propagation through the second portion of the additional conduit structure in order to obtain cooled other gas. The additional conduit structure defines a return portion for returning the cooled gas to the first portion. The additional conduit structure can comprises a closure or more than one closure that can be actuated to prevent the other gas from flowing through the additional conduit structure when the nuclear reactor operates. In some instances, the closure or more than one closure can be a louver or more than one louver.

In some instances and in all the aspects, instead of a gas being used to cool the reactor and/or the vault, other suitable fluids present in the conduit structure, partially in the liquid phase and partially in the gaseous phase can be used. As an example, water could be used.

### BRIEF DESCRIPTION OF THE FIGURES

FIG. 1 shows a nuclear reactor system that includes an embodiment of a cooling system in accordance with the present disclosure.

FIG. 2 shows a nuclear reactor system that includes another embodiment of a cooling system in accordance with the present disclosure.

FIG. 3 shows a nuclear reactor system that includes yet another embodiment of a cooling system in accordance with the present disclosure.

FIG. 4 shows a nuclear reactor system that includes an additional embodiment of a cooling system in accordance with the present disclosure.

FIG. 5 shows an embodiment of a conduit with a closure that can be used to stop a gas from flowing in some embodiments of the cooling system in accordance with the present disclosure.

### DETAILED DESCRIPTION

The cooling system of the present disclosure allows for decay heat removal from a nuclear core of a nuclear reactor when the nuclear reactor cesses to operate due to unforeseen conditions such as, for example, loss of electrical power to pumps circulating the primary coolant in the nuclear reactor. The cooling system of the present disclosure has a conduit structure that defines a sealed closed circuit through which a cooling fluid (a gas or a two phase gas/liquid) circulates through natural convection. In some embodiments, the cooling system of the present disclosure is always functioning, that is, the cooling system continuously extracts heat from the nuclear core. In these embodiments, the cooling system does not need to be actuated in any way when the nuclear reactor shuts down unexpectedly. The heat extracted by the cooling system during operation of the nuclear reactor is wasted instead of being used externally to perform work (e.g. to power an electrical generator). However, the fraction of the heat wasted can be of the order of 1% or less, which can be seen as being a small cost to pay for the benefit of having increased control over decay heat management. As an additional benefit, always having the cooling system running helps cool the silo environment in which the nuclear reactor is disposed, which keeps the reactor vessel (the vessel that contains the nuclear core) at a lower operating temperature.

Alternatively, in other embodiments, the cooling system of the present disclosure can be actively or passively activated. For example, in such embodiments, louvers (or any other suitable type of closures) can be installed in the cooling system and configured to open upon loss of electrical power. Opening of the louvers allows the cooling system to effectively remove decay heat when needed. In other embodiments, the louvers can be controlled by an operator and actuated at any time.

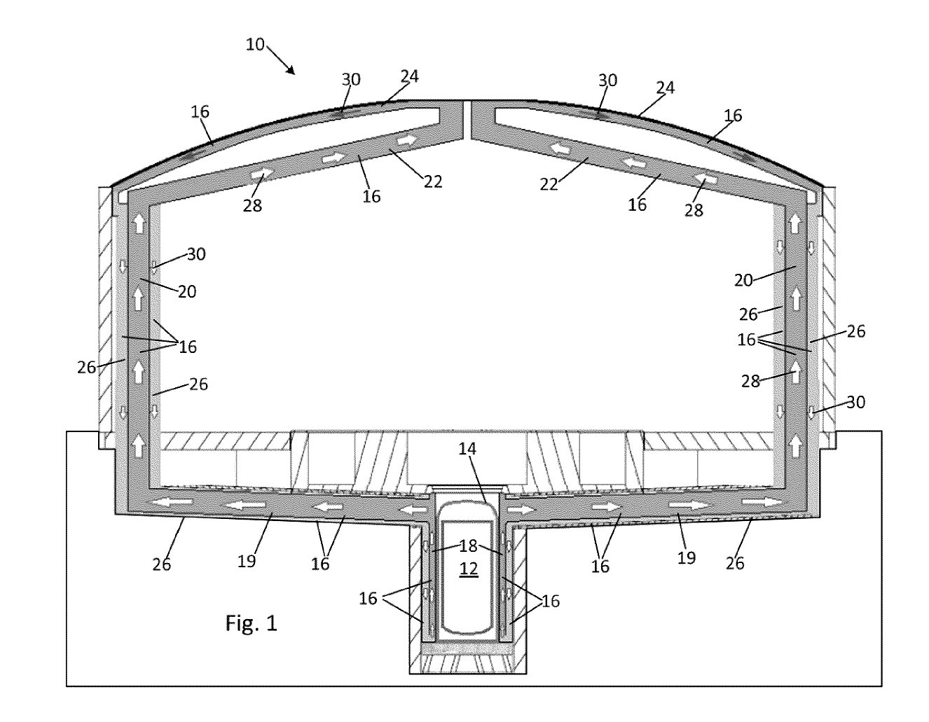

FIG. 1 shows an embodiment of a nuclear reactor system 10 that comprises a cooling system in accordance with the present disclosure. The nuclear reactor system 10 has a reactor 12 (reactor vessel that contains the reactor core) contained in a guard vessel 14. The reactor 12 can be any suitable type of nuclear reactor such as, for example, a molten salt nuclear reactor. The guard vessel 14 is in thermal contact with the reactor 12. That is, some heat generated by the reactor 12 is transferred to the guard vessel 14, by heat radiation, conduction, and/or convection. In other embodiments that are within the scope of the present disclosure, there may not be a guard vessel.

The nuclear reactor system 10 comprises a cooling system 16, which can include any suitable type of conduit structure that defines a sealed closed circuit in which a fluid (a coolant fluid) can circulate. In the context of the present disclosure, a sealed closed circuit is a circuit that retains the fluid circulating therein without releasing the fluid to the atmosphere. The sealed closed circuit is not in fluid communication with the atmosphere during operation of the cooling system. However, the sealed closed circuit may have access ports to insert and/or remove fluid in/from the sealed closed circuit when the cooling system is not in operation. In the context of the present disclosure, having a fluid communication between objects or spaces means that there is path for fluid to flow between the objects or spaces.

Further, the conduit structure is not in the reactor itself and the heat removed by the conduit structure is not used to perform work. That is, the conduit structure is formed outside the nuclear reactor. As such, the fluid circulating in the conduit structure is not a coolant used to remove heat from the nuclear reactor core and to transfer that heat to electrical generators or any device that can perform work.

The cooling system 16 has a portion 18 (bottom portion or first portion or heat source portion) that is in thermal contact with the reactor 12 and/or the guard vessel 14. That is, the bottom portion 18 is positioned to receive heat generated by the reactor 12 and/or the guard vessel 14, through heat radiation, conduction, and/or convection. The heat generated by the nuclear core is transmitted out of the nuclear reactor core through the vessel wall of the nuclear reactor. The gas present and/or circulating in the cooling system 16, at the portion 18, is heated by the heat received from the reactor 12 and/or the guard vessel 14. The heated gas at the bottom portion 18 will naturally tend to rise in the cooling system 16.

The bottom portion 18 can have any suitable form. For example, the bottom portion 18 can be cylinder-shaped with a diameter selected to surround the reactor 12 and or the guard vessel 14. A cylinder-shaped bottom portion can have, in some embodiments a flooring portion disposed beneath the reactor 12 and/or the guard vessel 14. The bottom portion 18 does not need to be cylinder-shaped.

The cooling system 16 comprises a floor portion 19 and a wall portion 20 that extends vertically to allow the heated gas to rise. The floor portion 19 can be at any suitable angle what will allow heated gas to move from the bottom portion to the wall portion 20. The wall portion 20 can extend vertically at any suitable angle that allows heated gas to rise. The cooling system 16 further comprises a ceiling portion 22 and a roof portion 24. As such, the gas heated at the bottom portion 18 moves (rises), through convection, towards the floor portion 19, moves laterally outwards in the floor portion 19, reaches the wall portion 20, rises in the wall portion 20, reaches the ceiling portion 22, and then the roof portion 24. The ceiling portion 22 can extend from the wall portion at any suitable angle. For example, in some embodiment, the angle can range from 2 to 10 degrees.

The floor portion 19, the wall portion 20, the ceiling portion 22 and the roof portion 24 can be considered as being part of a second portion of the conduit structure.

As the heated gas moves from the bottom portion 18 toward the roof portion 24, it dissipates heat to the environment surrounding the cooling system and cools. The roof portion 24 can be in contact with the outside atmosphere to allow efficient heat transfer from the roof portion 24 to the outside atmosphere. The materials used for the various portions of the cooling system 16 can be selected to allow optimal heat transfer from the cooling system to the environment that is in contact with the various portions of the cooling system. For example, the material can be, in some embodiments, stainless steel or mild steel.

The hot gas that has cooled while circulating toward the roof portion 24 is then directed towards where it started its ascent. That is, the cooled gas at the roof portion 24 is directed to the bottom portion 18 of the cooling system 16. As shown at FIG. 1, the roof portion 24 is slanted towards the outer periphery of the nuclear reactor system 10. The roof portion 24 in FIG. 1 defines a dome; however, this need not be the case. The roof portion can have any suitable shape (e.g., it can define a slanted plane). There, a return portion 26 connects the roof portion 24 to the bottom portion 18, where the cycle is repeated. In the present embodiment, the return portion 26 can be considered as being part of the wall portion. In this case, the wall portion has a section in which the fluid rises toward the ceiling and roof, and an adjoining section where the fluid descends toward the bottom portion 18. In other embodiments, the return portion can be distinct from the wall portion and have any suitable shape (e.g., cylindrical shape, pillar shape, etc.)

The ceiling portion and the roof portion do not need to strictly be a ceiling or a roof, respectively. That is, the ceiling portion 22 can have another structure, not necessarily part of the cooling system, formed beneath that would block the ceiling portion 22 from view. With respect to the roof portion 24, it can have a further structure, not necessarily part of the cooling system, formed above it, which would block the roof portion 26 from view. As such, the ceiling portion can be referred to as a first upper portion and the roof portion can be referred to as a second upper portion. The first upper portion and/or the second upper portion can be covered from view.

In FIG. 1, the arrows 28 and 30 indicate the direction of flow of the gas in the cooling system 16. Arrows 28 indicate gas that is rising while arrows 30 indicate gas that is descending.

As will be understood by the skilled worker, the cross-section area of the aforementioned portions of the cooling system 16 can be dimensioned to have the gas circulate, through the cooling system, at a constant speed. That is, as will be understood by the worker skilled in the art, cross-section areas of portions of the cooling system where the gas is cooler can be smaller than portions where the gas is hotter.

In other embodiments, instead of having a single phase coolant, such as a gas, it is possible to have a two phase coolant such as, for example, water. When such a two phase coolant is used, coolant in the liquid phase, present at the portion 18, extracts heat from the reactor 12 and/or guard vessel 14. Eventually, when the coolant has extracted a sufficient quantity of heat, it changes into the gas phase and begins moving towards the roof portion 24. At the roof portion 24, the coolant, having sufficiently cooled, returns to the liquid phase and drips down toward the portion 18, where the cycle is repeated. In some embodiments, it is possible for the coolant to change from the gas phase to the liquid phase prior to reaching the roof portion 24, and to drip back toward the portion 18, in the same portion of the cooling system 18 through which the coolant—in the gas phase—rose.

As the cooling system 16 circulates a gas or liquid in close proximity to the nuclear reactor 12, the possibility of radioactive activation of the gas or liquid by neutrons escaping the reactor vessel exists. However as the cooling system 16 is a closed loop (closed circuit), it prevents any emission of activated products to the atmosphere. If and when there is a leak of any radioactive material from the reactor 12 into the cooling system 16, again, as the cooling system is designed as a closed loop, any release of radioactive material to the atmosphere can be avoided.

Further, in the event where the cooling system 16 should become open (e.g., breakage of the roof) and air enter the cooling system, the cooling of the reactor 12 and/or guard vessel 14 would become more efficient and not lead to overheating of the reactor 12. That is, the removal of decay heat would not be adversely affected. In any such situation, the nuclear reactor can be shutdown to reduce to a negligible amount any neutron fluence reaching the cooling system 16. As such, if the now open cycle cooling system 16 is circulating air in the vicinity of the reactor (e.g., portion 18), very little radioactive activation products such as Argon 41 (⁴¹Ar) would be produced and/or released to the atmosphere.

In other embodiments, the cooling system, instead of having a roof as shown in FIG. 1, could instead have a conduit structure that circulates the coolant outside of the building where the reactor is housed. For example, the conduit structure in question could be located outside, at the side of building in question. Such a conduit structure transferring heat to the atmosphere would be at a higher elevation than the reactor and/or guard vessel to ensure natural circulation of the fluid in the conduit structure of the cooling system.

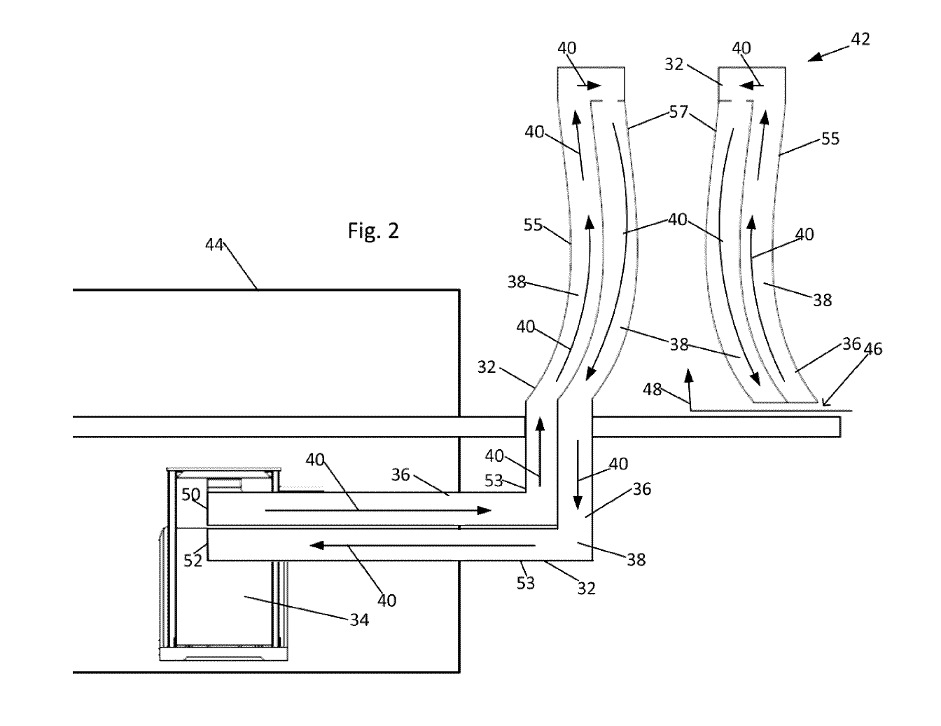

FIG. 2 shows a cut-away view of such an embodiment of the cooling system of the present disclosure connected to a nuclear reactor. In this embodiment, the cooling system 32 has a conduit structure with a heat source portion 34 (first portion) that surrounds the nuclear reactor and/or its guard vessel (not shown). The heat source portion 34 is in thermal contact with the nuclear reactor and/or the guard vessel. The cooling system 32 defines a closed circuit 36 through which a gas 38 circulates through convection. The arrows 40 indicate the direction taken by the gas 38 as it flows through the cooling system 32. The cooling system 32 has a cooling tower 42 located outside the building 44 in which the nuclear reactor and its guard vessel are housed. The cooling tower 42 can be designed with openings such as opening 46 al its bottom section, in order to allow for air to circulate, as indicated by arrow 48, from the outside of the cooling tower through the cooling tower 42 (which can be considered a second portion of the conduit structure). The cooling tower can define a hyperbolic shape. The heat source portion 34 is connected to cooling tower 42 through conduits 53. Although not apparent from FIG. 2, the outside portions 55 of the cooling tower 42 are in fluid communication with each other and, the inside portions 57 of the cooling tower 42 are in fluid communication with each other. And, clearly, the inside portions are in fluid communication with the outside portions. As would be understood by one skilled in the art, such a cooling tower arrangement allows for a strong updraft of the outside air up through the tower which aids in heat removal from the cooling system 32 and increases the heat transfer coefficient, which results in a lowering of needed surface area of the cooling tower.

The heat source portion 34 is configured to have the gas 38 circulate therein. Gas that has received heat from the nuclear reactor and the guard vessel while propagating in the heat source portion 34 rises and exits the first portion 34 at the first connection 50. This hot gas dissipates its heat as it circulates though the cooling tower 42 and re-enters the heat source portion 34 at connection 52.

In addition to cooling the guard vessel and/or the reactor itself, the cooling system of the present disclosure can be used to cool any other part of the facility in which the reactor is installed. For example, in some instances, the facility in question may have a section for storing spent nuclear fuel such as, for example, spent molten fuel salt. In such facilities, the cooling system used for cooling the reactor and/or guard vessel can be configured to also cool the area of the facility where the spent nuclear fuel is stored. In other embodiments, a separate cooling system can be used and the separate cooling system can be a duplicate or a scaled duplicate of the cooling used by the reactor and/or guard vessel.

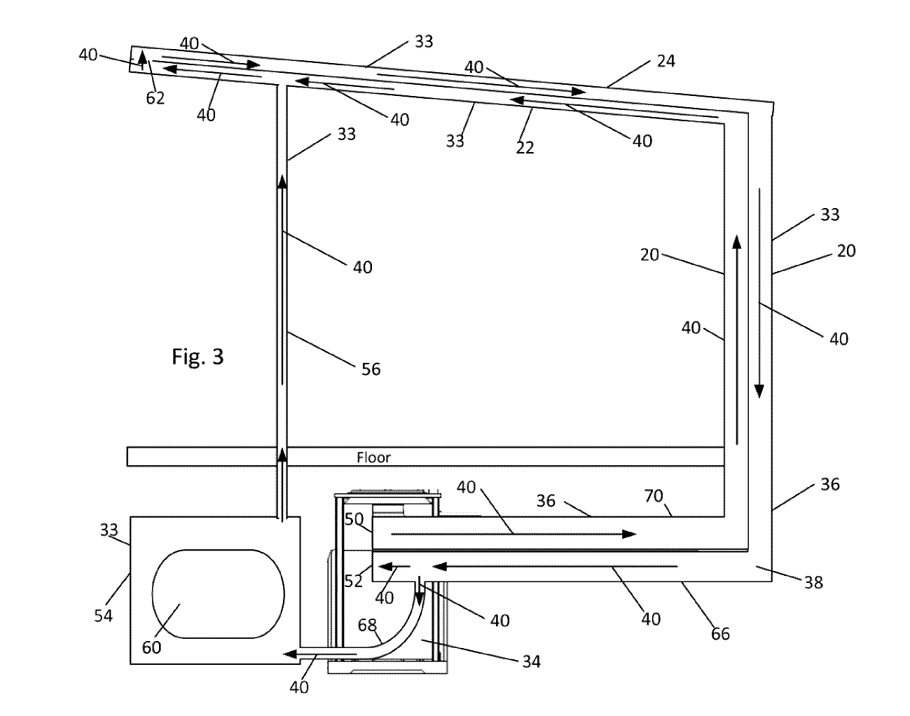

FIG. 3 shows a cross-sectional view of yet another embodiment of the cooling system 33 of the present disclosure, connected to a nuclear reactor. In this embodiment, the cooling system 33 is connected to (i.e., is in thermal contact with) a heat source portion 34 (first portion) surrounding the nuclear reactor and its guard vessel (not shown). The cooling system 33 defines a closed circuit 36 through which a gas 38 circulates through convection. The arrows 40 indicate the direction taken by the gas 38 as it flows through the cooling system 33. The cooling system 33 has a wall portion 20, a ceiling portion 22, a roof portion 24, a vault portion 54 and a riser portion 56.

The vault portion 54 contains or is designed to contain spent nuclear fuel such as, for example, spent molten fuel salt, in a container 60. The gas in the vault 54 is in thermal contact with the container 60 and is heated by the spent nuclear fuel through the container 60. The heated gas rises from the vault 54 to the ceiling portion 22, through a riser 56. That is, the riser 56 is part of the cooling system 33 and interconnects the vault 54 to the ceiling portion 22. Upon reaching the ceiling portion 22, the gas received from the riser 56 continues to rise and propagate in the ceiling portion 22 up to the opening 62, which connects (fluidly connects) the ceiling portion 22 to the roof portion 24. As the gas cools, it propagates downward in the roof portion 24 and the wall portion 20. The cooled gas continues to propagate in the conduit section 66 towards the guard vessel 34. Part of the cooled gas is branched out of the conduit section 66 into an ancillary conduit 68 that connects the conduit section 66 to the vault 54. When the cooled gas arrives at the vault 54, the cycle where the gas extracts heat from the spent nuclear fuel, propagates up through the riser 56 and subsequently returns to the vault, is repeated. Even though only one vault 54 is shown in FIG. 3, any number of vaults can be connected to and be part of the cooling system 33.

The gas in the conduit section 66 that returns to the heat source portion 34 is heated by the guard vessel and/or reactor. The heated gas rises in the heat source portion 34 and exits the heat source portion 34 into the conduit section 70. The gas then propagates upwardly in the wall portion 20, reaches the ceiling portion 22, and then the roof portion 24, and then back down toward the heat source portion 34.

As the heated gas moves from the conduit portion 70 toward the roof portion 24, it dissipates heat to the environment surrounding the cooling system and cools. The roof portion 24 can be in contact with the outside atmosphere to allow efficient heat transfer from the roof portion 24 to the outside atmosphere. The materials used for the various portions of the cooling system 16 can be selected to allow optimal heat transfer from the cooling system to the environment that is in contact with the various portions of the cooling system.

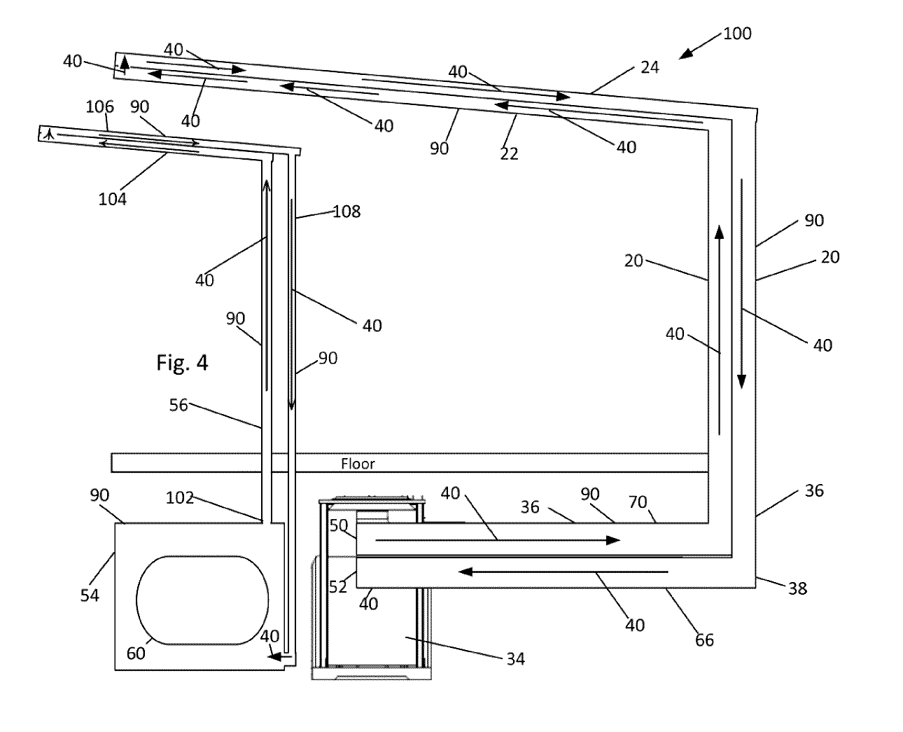

FIG. 4 shows an additional cooling system 100 In accordance with the present disclosure. The cooling system 100 comprises the cooling system 90, which is configures to cool the nuclear reactor only. The cooling system 90 is essentially the same as the cooling system 33 of FIG. 3 but is not configured to cool any type of vault. Returning to FIG. 4, the vault 54, which represents one or more than one vault, has a dedicated cooling system 92 that works similarly to the cooling system 90. The vault 54 has a first portion 102 connected thereto and in thermal contact therewith. The first portion connects, through a riser 56, to a ceiling portion 104 and a roof portion 106. A return portion (another conduit) 108 returns the cooled gas to the vault 54. The vault 54, riser 56, celling 104, roof 106 and return portion 108 define a sealed conduit structure that is configured to contain a fluid used for cooling the vault 54.

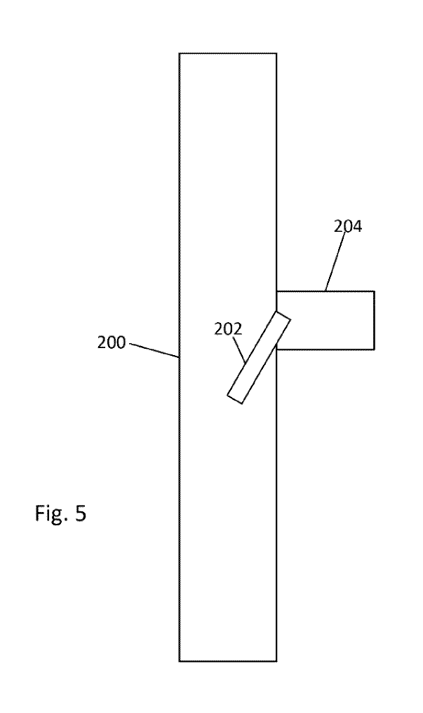

FIG. 5 shows a cutaway view of a conduit 200 that can be part of the above described embodiments. The conduit 200 has a louver 202 installed therein in accordance. The louver is in the open position and allows gas to flow in the conduit structure. The closed position is defined, in this embodiment, by the louver being horizontally disposed (not shown), rather than obliquely as in this figure. The louver 202 is connected to a louver actuator 204 that allows the louver 202 to open when power to the louver controller 204 is lost. Closures other than louvers can be used without departing from the scope of the present disclosure. Such closures can be installed anywhere in the conduit structures that define a sealed closed loop through which a cooling fluid circulates to cool either a nuclear reactor, a spent fuel vault, or both.

The cooling system of the present disclosure allows for decay heat removal from a nuclear core of a nuclear reactor when the nuclear reactor cesses to operate due to unforeseen conditions such as, for example, loss of electrical power to pumps circulating the primary coolant in the nuclear reactor. In some embodiments, the cooling system of the present disclosure is always functioning, that is, is always extracting heat from the nuclear core, the cooling system does not need to be actuated in any way when the nuclear reactor shuts down unexpectedly. In these embodiments, the heat extracted by the cooling system during operation of the nuclear reactor is wasted instead of being used externally to perform work (e.g., to power an electrical generator). However, the fraction of the heat wasted can be of the order of 1% or less, which can be seen as being a small cost pay for the benefit of having increased control over decay heat management. In other embodiments, closures disposed in the cooling system allow the cooling system to be turned on and off, either automatically upon loss of electrical power or deliberately by an operator.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

1. A cooling system for a nuclear reactor, the system comprising:
a conduit structure defining a sealed closed circuit, the conduit structure being formed outside the nuclear reactor, the conduit structure to hold a gas therein,
the conduit structure having a first portion in thermal contact with the nuclear reactor, the first portion configured to transfer heat from the nuclear reactor to the gas present in the first portion, the heat transferred to the gas to heat the gas in order to obtain heated gas,
the conduit structure having a second portion located higher than the first portion, the second portion being in thermal contact with an environment,
the conduit structure configured for the heated gas to propagate, by natural convection, from the first portion to the second portion, the heated gas to propagate through the second portion and to transfer heat to the environment as the heated gas propagates through the second portion, the heated gas to cool during propagation through the second portion in order to obtain cooled gas,
the conduit structure defining a return portion for returning the cooled gas to the first portion,
the cooling system configured to continuously remove heat from the nuclear reactor during operation of the nuclear reactor and when the nuclear reactor stops operating and generates decay heat.

2. The system of claim 1 wherein the first portion of the conduit structure is configured to receive heat from the nuclear reactor through at least one of heat radiation, heat conduction, and heat convection.

3. The system of claim 1 or claim 2 wherein the first portion is cylindrically shaped and surrounds the nuclear reactor.

4. The system of any one of claims 1-3 wherein the second portion of the conduit structure defines a wall.

5. The system of claim 4 wherein the second portion of the conduit structure further defines a ceiling portion formed above the wall portion.

6. The system of claim 4 wherein the second portion of the conduit structure further defines a roof portion that extends over the ceiling portion.

7. The system of claim 5 or claim 6 wherein the ceiling portion extends from the wall portion at an angle ranging between 2 and 10 degrees.

8. The system of claim 6 or claim 7 wherein the roof portion defines a dome.

9. The system of claim 4 wherein the second portion of the conduit structure further defines first upper portion formed above the wall portion.

10. The system of claim 4 wherein the second portion of the conduit structure further defines a second upper portion that extends over the first upper portion.

11. The system of claim 9 or claim 10 wherein the first upper portion extends from the wall portion at an angle ranging between 2 and 10 degrees.

12. The system of claim 10 or claim 11 wherein the second upper portion defines a dome.

13. The system of any one of claims 1-3 wherein the second portion comprises a cooling tower.

14. The system of any one of claims 1-13 wherein the conduit structure further comprises a vault far storing spent nuclear fuel, a riser for fluidly connecting the vault to the second portion, and an ancillary conduit fluidly connecting the vault to the return portion.

15. The system of any one of claims 1-14 wherein the gas includes at least one of air, nitrogen and carbon dioxide.

16. The system of anyone of claims 1-15 further comprising:
one or more than one vault for storing spent nuclear fuel; and
a vault cooling system for cooling the one or more than one vault, the vault cooling system comprising:
an additional conduit structure defining an additional sealed closed circuit, the additional structure to hold another gas therein,
the additional conduit structure having a first portion in thermal contact with the one or more than vault, the first portion of the additional conduit structure configured to transfer heat from the one or more than one vault to the other gas present in the first portion of the additional conduit structure, the heat transferred to the other gas to heat the other gas in order to obtain another heated gas,
the additional conduit structure having a second portion located higher than the first portion, the second portion of the additional conduit structure being in thermal contact with another environment,
the additional conduit structure configured for the heated other gas to propagate, by natural convection, from the first portion of the additional conduit structure to the second portion of the additional conduit structure, the heated other gas to propagate through the second portion of the additional conduit structure and to transfer heat to the other environment as the heated other gas propagates through the second portion of the additional conduit structure, the heated other gas to cool during propagation through the second portion of the additional conduit structure in order to obtain cooled other gas,
the additional conduit structure defining a return portion for returning the cooled other gas to the first portion of the additional conduit structure,
the vault cooling system configured to remove heat from the one or more than one vault during operation of the nuclear reactor and when the nuclear reactor stops operating.

17. The system of claim 16 wherein the environment and the other environment are the same.

18. The system of claim 1 or claim 17 wherein the environment is an outside environment.
